(19) United States
(12) Patent Application Publication
(10) Pub. No.: US 2019/0354599 A1
(43) Pub. Date: Nov. 21, 2019

(54) AI MODEL CANVAS

(71) Applicant: MICROSOFT TECHNOLOGY LICENSING, LLC, Redmond, WA (US)

(72) Inventors: Vijay Mital, Kirkland, WA (US); Liang Du, Redmond, WA (US); Ranjith Narayanan, Bellevue, WA (US); Robin Abraham, Redmond, WA (US)

(21) Appl. No.: 16/024,267

(22) Filed: Jun. 29, 2018

Related U.S. Application Data
(60) Provisional application No. 62/674,358, filed on May 21, 2018.

(51) Int. Cl. G06F 17/30; G06N 99/00; G06F 3/0481; G06F 3/0482; H04L 12/24

(52) U.S. Cl. CPC G06F 17/3056; G06N 99/005; H04L 41/16; G06F 3/0482; G06F 3/04817

(57) ABSTRACT

Providing an improved user interface to a user for facilitating data management produced by artificial intelligence. A method includes receiving user input adding an input dataset to an active area of a user interface. The method further includes receiving user input adding an artificial intelligence model to the active area of the user interface. The method further includes, based on the user adding the artificial intelligence model to the active area of the user interface, providing feedback on the user interface to the user indicating an effect of adding the artificial intelligence model to the active area of the user interface.

### BACKGROUND

### Background and Relevant Art

Evaluation of data has become a complex and computing intensive process. In particular, huge amounts of data can be collected from various sources and it can be difficult to characterize and/or collect useful information about the data. For example, consider a single image. The single image may have millions of pixels where each of the pixels has various characteristics associated with it. Additionally groups of pixels can have characteristics associated with them. Additionally, real-world items may be represented within the image. Additionally, certain artistic styling may have been taken into consideration when generating the image. Evaluating all of the data that can be extracted about an image is virtually impossible for a user to do. Thus, computing technology is implemented to facilitate characterization and study of large datasets.

One way that this characterization and study has been performed in recent times includes the use of artificial intelligence. Artificial intelligence (AI) includes computer implemented decision-making that is able to process large amounts of data. For example, rule-based algorithms and/or machine learning algorithms can be used to implement AI. In particular, AI models have an input dataset applied to them and produce raw output data.

However, the raw output data can still be difficult for a user to interpret and/or visualize. In particular, the AI model does not necessarily produce the most useful raw data for use by the user.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method of providing an improved user interface to a user for facilitating data management produced by artificial intelligence. The method includes receiving user input adding an input dataset to an active area of a user interface. The method further includes receiving user input adding an artificial intelligence model to the active area of the user interface. The method further includes, based on the user adding the artificial intelligence model to the active area of the user interface, providing feedback on the user interface to the user indicating an effect of adding the artificial intelligence model to the active area of the user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a state of a user interface for interactively presenting to a user effects of applying artificial intelligence models to input datasets;

FIG. 2 illustrates another state of the user interface for interactively presenting to a user effects of applying artificial intelligence models to input datasets;

FIG. 3 illustrates another state of the user interface for interactively presenting to a user effects of applying artificial intelligence models to input datasets;

FIG. 4 illustrates another state of the user interface for interactively presenting to a user effects of applying artificial intelligence models to input datasets;

FIG. 5 illustrates another state of the user interface for interactively presenting to a user effects of applying artificial intelligence models to input datasets;

FIG. 6 illustrates another state of the user interface for interactively presenting to a user effects of applying artificial intelligence models to input datasets;

FIG. 7 illustrates another state of the user interface for interactively presenting to a user effects of applying artificial intelligence models to input datasets;

FIG. 8 illustrates another state of the user interface for interactively presenting to a user effects of applying artificial intelligence models to input datasets;

FIG. 9 illustrates another state of the user interface for interactively presenting to a user effects of applying artificial intelligence models to input datasets;

FIG. 10 illustrates another state of the user interface for interactively presenting to a user effects of applying artificial intelligence models to input datasets;

FIG. 11 illustrates another state of the user interface for interactively presenting to a user effects of applying artificial intelligence models to input datasets;

FIG. 12 illustrates another state of the user interface for interactively presenting to a user effects of applying artificial intelligence models to input datasets;

FIG. 13 illustrates another state of the user interface for interactively presenting to a user effects of applying artificial intelligence models to input datasets;

FIG. 14 illustrates another state of the user interface for interactively presenting to a user effects of applying artificial intelligence models to input datasets;

FIG. 15 illustrates another state of the user interface for interactively presenting to a user effects of applying artificial intelligence models to input datasets;

FIG. 16 illustrates another state of the user interface for interactively presenting to a user effects of applying artificial intelligence models to input datasets;

FIG. 17 illustrates another state of the user interface for interactively presenting to a user effects of applying artificial intelligence models to input datasets;

FIG. 18 illustrates another state of the user interface for interactively presenting to a user effects of applying artificial intelligence models to input datasets;

FIG. 19 illustrates another state of the user interface for interactively presenting to a user effects of applying artificial intelligence models to input datasets;

FIG. 20 illustrates another state of the user interface for interactively presenting to a user effects of applying artificial intelligence models to input datasets;

FIG. 21 illustrates another state of the user interface for interactively presenting to a user effects of applying artificial intelligence models to input datasets;

FIG. 22 illustrates another state of the user interface for interactively presenting to a user effects of applying artificial intelligence models to input datasets;

FIG. 23 illustrates another state of the user interface for interactively presenting to a user effects of applying artificial intelligence models to input datasets;

FIG. 24 illustrates another state of the user interface for interactively presenting to a user effects of applying artificial intelligence models to input datasets; and

FIG. 25 illustrates a method of providing a user interface for facilitating data management produced by artificial intelligence.

### DETAILED DESCRIPTION

Some embodiments implement what is referred to herein as an artificial intelligence (AI) canvas. The AI canvas is an AI processing platform that includes a user interface, such as a graphical user interface, that is able to immediately and interactively present to a user the impact of recently performed actions. In some embodiments, the interface is able to present the impact of the very last thing that was performed by the user. In particular, the interface can present to the user a history of effects caused by the user in the context of AI.

In the AI canvas, a user can add and arrange datasets, add and arrange AI models that are applied on the datasets, and immediately and interactively see the output in a way that allows the user to understand the impact of the last thing (or group of things) they (the user) did.

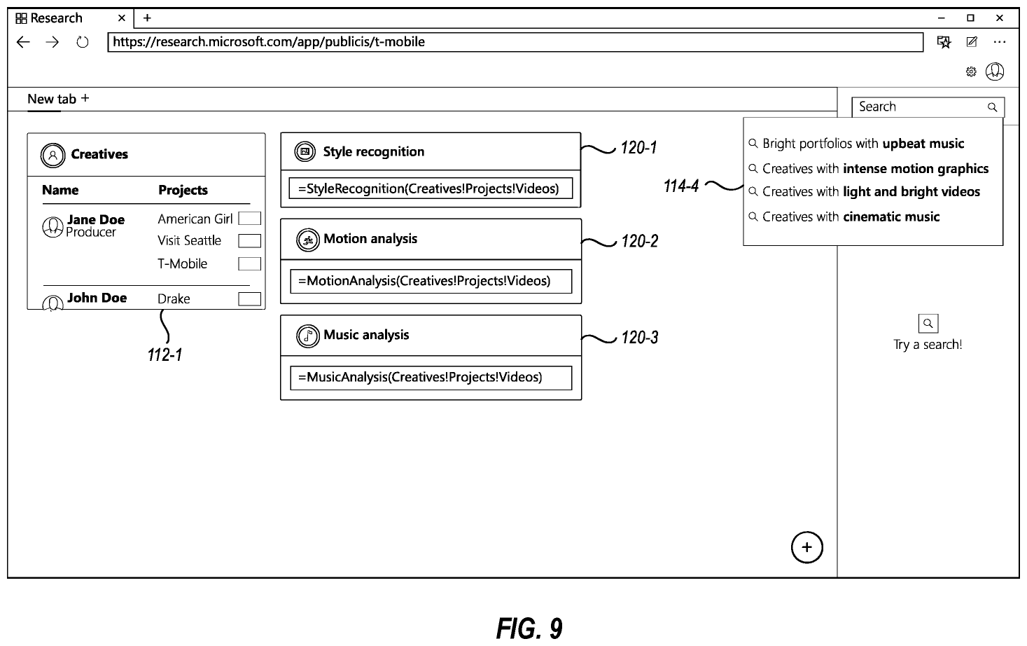

For example, attention is now directed to FIG. 9 which illustrates a particular state of the AI canvas 100. In the example illustrated in FIG. 9, a creatives' input dataset 112-1 is added to the AI canvas 100, which includes a set of data including creatives' that created projects, along with the projects, including certain advertising campaigns, where each of the advertising campaigns is a video including motion and music. In this example, the user has also added a number of AI models including a style recognition AI model 120-1, a motion analysis AI model 120-2, and a music analysis AI model 120-3. The music analysis AI model 120-3 is the most recently added model in a temporal sense.

As a result, the AI canvas 100 will provide various suggested queries 114-4 to the user, where the suggested queries are dependent on the history of actions performed by the user. For example, the AI canvas 100 provides the suggested queries ‘bright portfolios with upbeat music’, ‘creatives with intense motion graphics’, ‘creatives with light and bright videos’, and ‘creatives with cinematic music’. The first suggested query, i.e. ‘bright portfolios with upbeat music’ is a result of the addition of the ‘style recognition’ and ‘music analysis’ AI models 120-1 and 120-3. The fourth suggestion, i.e. creatives with cinematic music' is provided based only on the addition of the ‘music analysis’ AI model 120-2. Thus, some suggestions provided by the AI canvas may be based only on the last action performed by the user on the AI canvas. Embodiments may include functionality for showing an impact attributable solely on the last model applied. Alternatively or additionally, embodiments may incrementally show an impact based on a last added model combined with previous models added to the AI canvas. Alternatively or additionally other user interactions with the AI canvas may be illustrated. For example, in some embodiments, selection of certain suggested queries may affect what suggested queries are provided in the future. Thus, embodiments provide feedback indicating what a user has achieved by adding or editing a model. In some embodiments, ordering of suggested queries may help the user understand this feedback. Some embodiments include suggested queries that combine added models. Thus, embodiments may provide hints on what was most recently added, combined with actions that were previously performed by the user.

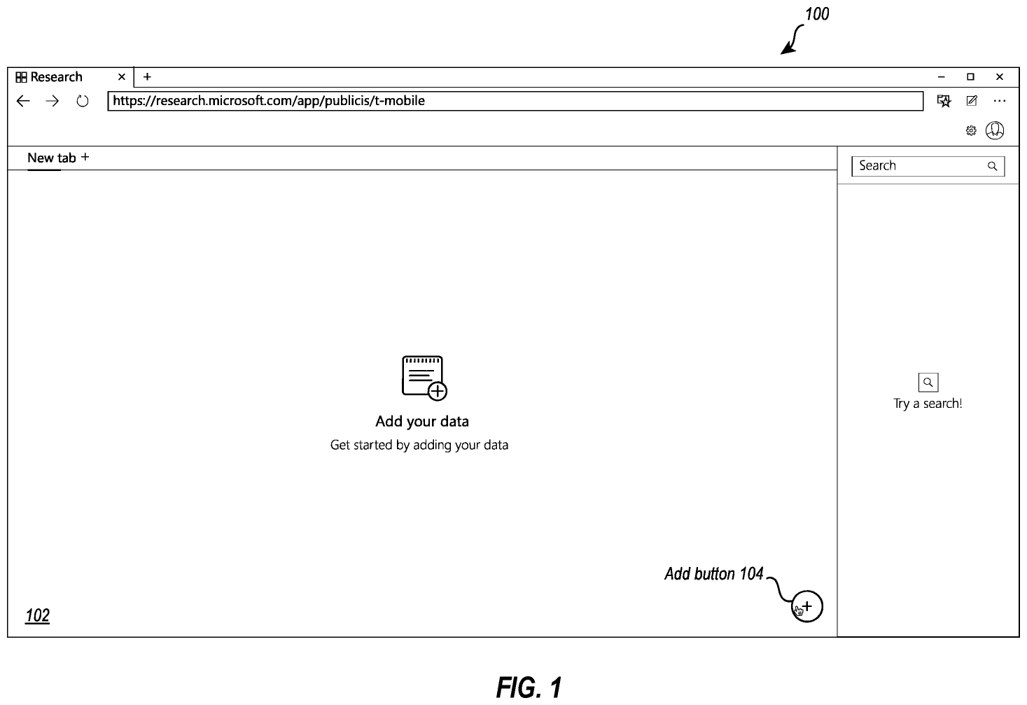

Referring now to FIGS. 1 through 24, examples are illustrated showing various functional features of the AI canvas. FIG. 1 illustrates a user interface 102, which in this example is a graphical user interface graphically displaying the AI canvas 100. In the AI canvas 100, the user can add data, add intelligence (e.g., AI models) perform queries on outputs from the intelligence, view results from the queries, create new datasets from the results, and share data from the AI canvas 102 with other users.

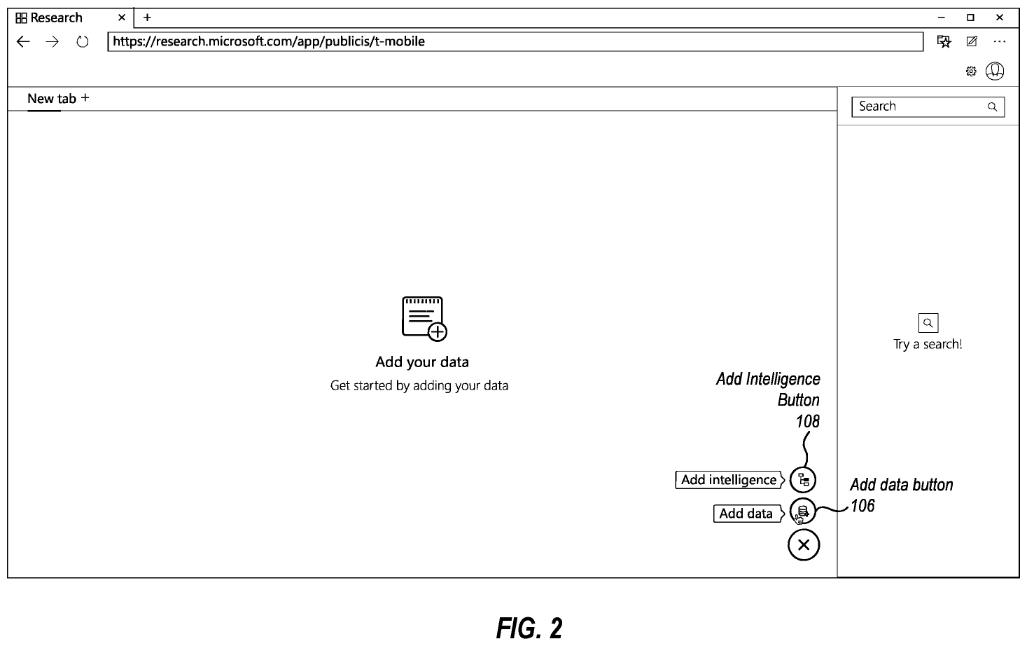

FIG. 1 illustrates a user interacting with an add button 104. Referring now to FIG. 2, selecting the add button 104 causes additional user interface elements to be displayed. In this particular example, an add data button 106 and an add intelligence button 108 are displayed in the AI canvas 100. FIG. 2 illustrates a user selecting the add data button 106.

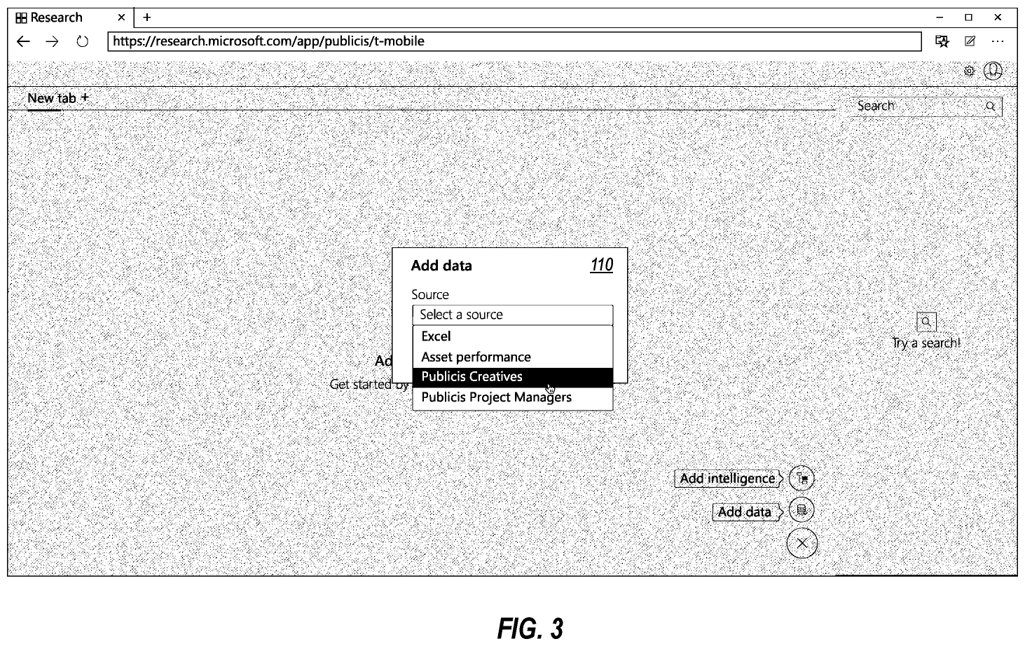

As illustrated in FIG. 3, an add data interface 110 is illustrated. In the example illustrated in FIG. 3, the add data interface allows a user to select a source of data. For example, a user can select a spreadsheet as a source of data, a database, a portion of the database, a document, a webpage, a website, a collection of images, a collection of videos, a collection of audio clips, or virtually any other dataset or collection of datasets. In the example illustrated in FIG. 3, the user selects a dataset which in this example is labeled ‘creatives”. For purposes of the present example, the creatives' dataset is a dataset for a fictitious company Publicis, where the dataset includes a list of content creators along with multimedia projects that the content creators have created for various advertising campaigns.

Adding a source of data to the user interface as an input dataset connects the source of data to the AI canvas 100 and allows the data in the source of data to be visualized in the AI canvas 100.

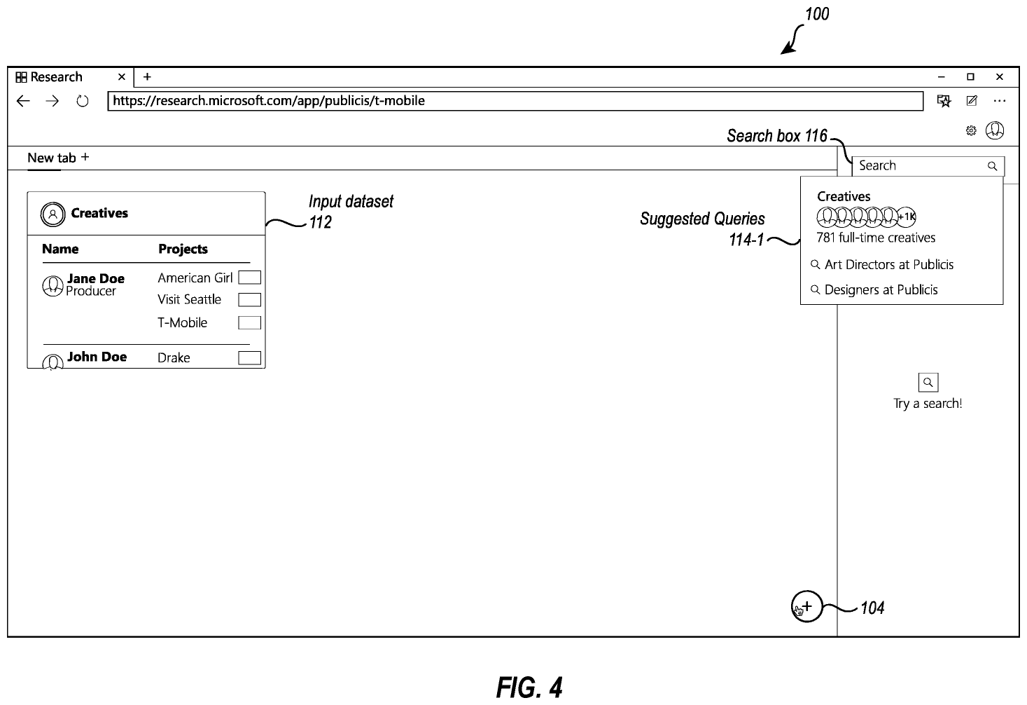

Reference is now made to FIG. 4 which illustrates the creatives' dataset as an input dataset 112-1. Embodiments may be implemented where any action by a user causes a reaction by the AI canvas where the reaction is a sort of history of one or more previous actions by the user. The example illustrated in FIG. 4 is one such example. In particular, the user adding the input dataset 112-1 causes suggested queries 114 to be displayed. In this example, the suggested queries 114 are queries that are relevant to the data in the input dataset 112-1. In particular, one of the suggested queries suggests that the user can search for ‘art directors at Publicis’. Another suggested query illustrated in FIG. 4 is ‘designers at Publicis’. Note that the user does not need to select one of these suggested queries, but rather could input their own query in the search box 116. If the user inputs their own query in the search box 116, that input query would be added to the corpus of actions performed by the user. Indeed, even selecting one of the suggested queries 114 would be added to the corpus of actions performed by the user. The AI canvas 100 could be configured to provide additional suggestions based on the selections.

The AI canvas 100 may be able to provide query suggestions based on various details about the dataset. For example, suggestions may be based on table and/or column headings in the data. Thus, for example, if a table heading is of a company, and a column heading in the data is for names of designers, a suggestion may be for designers at the company.

In another example embodiments may include an indexer that is able to index input datasets. Suggestions may be based on the results of this indexing. For example, particularly unique words appearing in the indexing process may be used in suggested searches.

Alternatively or additionally, embodiments may be able to access a pre-generated index for the dataset. Using the generated index or pre-generated index, embodiments can identify words or concepts that may be of particular interest. Suggestions may then be provided based on the various index entries in the index. Illustratively, some embodiments will elide commonly used connector words from the index (such as ‘and’, ‘the’, ‘a’, etc.). However, other significant common words may be used to identify ideas and concepts that may be of interest to users. These can be provided as part of suggested queries in meaningful ways that are understandable by the user.

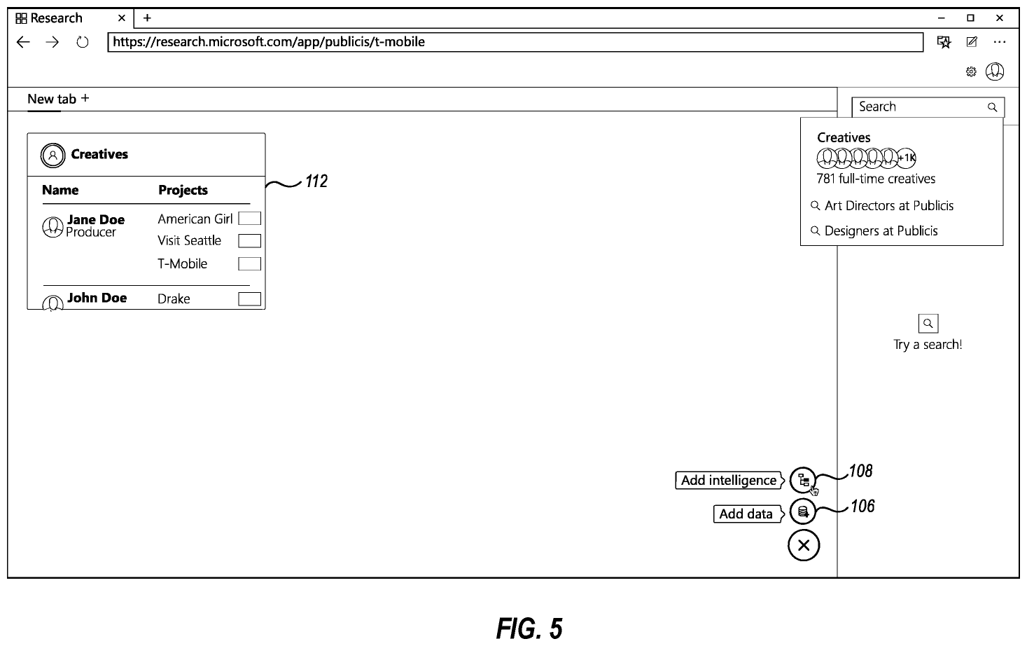

However, in the example illustrated in FIG. 4, the user once again selects the add button 104. As illustrated in FIG. 5, this causes the add data button 106 and the add intelligence button 108 to be displayed in the AI canvas 100. In the illustrated example, the user selects the add intelligence button 108.

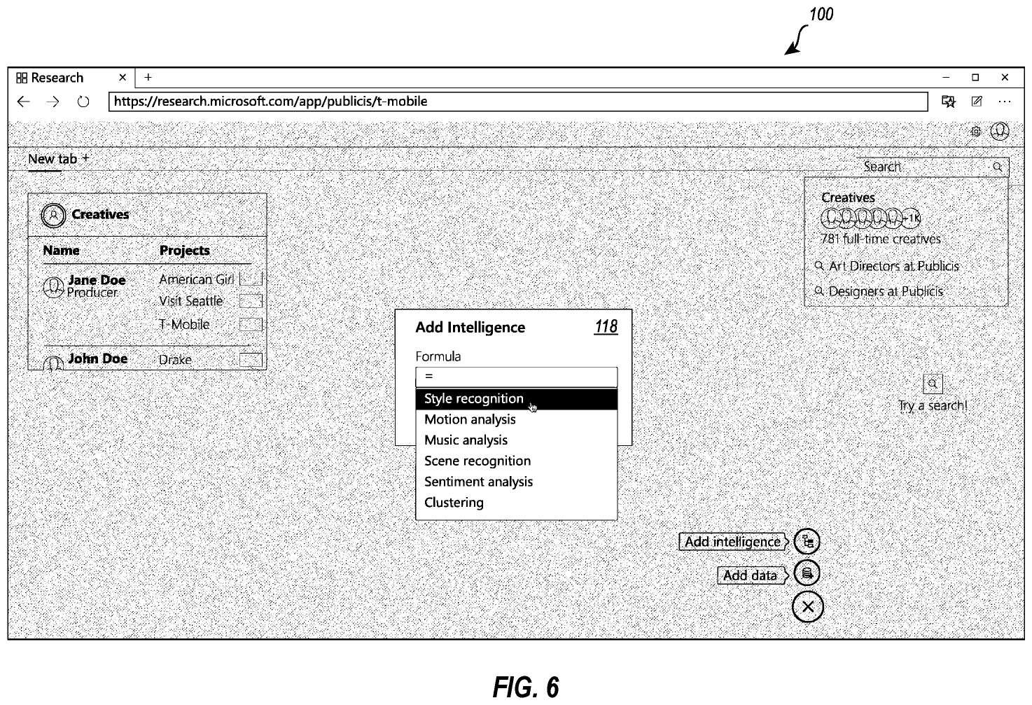

Selecting the add intelligence button 108 causes an add intelligence interface 118 to be displayed as illustrated in FIG. 6. Using this interface, the user can select various AI models to add to the AI canvas 100 such that the added UI models can be applied to the input dataset 112-1. In particular, adding an AI model to the AI canvas 100 causes the AI model to be applied to a dataset(s) that has been previously added to the AI canvas 100. For example, this may include causing various computing entities to apply various AI concepts to a dataset. For example, various rules from a rule-based AI model may be applied to input datasets to obtain output data. The output data is the result of application of an AI model to input dataset. The AI model determines what type of data will be output in the output data. For example, as illustrated below, and AI model may be configured to identify artistic styles of a video segments.

In another example, machine learning AI models can be implemented on computing entities to apply machine learning AI to input datasets to produce AI model output data.

In some embodiments, a computing entity may be a processor, memory, and/or other computer hardware that are configured with computer executable instructions such that the computer hardware is configured to apply AI models to input datasets to obtain output AI model data.

FIG. 6 illustrates the following AI models that can be added to the AI canvas 100: ‘style recognition’, ‘motion analysis’, ‘music analysis’, ‘scene recognition’, ‘sentiment analysis’, and ‘clustering’. Each of these are AI models that can be applied to the input dataset 112-1.

As noted above, when input datasets are operated on by AI models, raw data is produced. The raw data has a large amount of data produced, much of which will not typically be of interest to a user. Thus, some embodiments may refine the raw data into a refined data structure that can be used by the AI canvas 100 to provide suggested queries or other useful information to the user. In some embodiments, a refiner computing entity may be used to perform this functionality. The refinement may involve truncating, converting, combining, and/or otherwise transforming portions of the AI model output. The refinement may involve prioritizing portions of the output by perhaps ordering or ranking the output, tagging portions of the AI model output, and so forth. There may be a different refinement specified for each AI model or model type. There may even be a different refinement specified for each model/data combination including an AI model or model type with an associated input dataset or input dataset type. Upon obtaining output data from the AI model, the appropriate refinement may then be applied. The refinement may bring forth, for instance, what a typical user would find most relevant from a given AI model applied on given data. The actually performed refinement may be augmented or modified by hints specific to an AI model and/or by learned data.

As an illustrative example, certain types of AI models are typically used to try and produce certain types of data. Thus, data that is produced in the raw output data that is not of the type typically evaluated when using a particular AI model may be removed to create refined data.

In some embodiments, the refined data may then be semantically indexed to provide a semantic index that may then be queried upon by a user, or that may be used to suggest queries to a user. Semantic indexing, and the corresponding retrieval methods, are directed to identifying patterns and relationships in data. For example, some embodiments implementing semantic indexing can identify relationships between terms and concepts that are present in otherwise unstructured data. Thus, a semantic indexer may be able to take a set of unstructured data and identify various latent relationships between data elements in the unstructured data. In this way, a semantic indexer can identify expressions of similar concepts even though those expressions may use different language to express the same concepts. This allows data to be indexed semantically as opposed to merely indexing data based on element wise similarity.

A characterization structure might also include a set of one or more operators and/or terms that a query engine may use to query against the semantic index, or that may be included within the suggested queries presented to the user. By providing those operators and/or terms to a query engine, the user may more effectively use that query engine to extract desired information from the semantic index.

The characterization structure might also include a set of one or more visualizations that a visualization engine may use to visualize to a user responses to queries against the semantic index. Such visualizations may be those that for the given semantic index, most effectively and intuitively represent the output of a query to a user. Thus, the characterization structure may also provide mechanisms to effectively interface with a semantic index generated from the refined output of the AI model. The characterization structure may be easily expanded as new AI model and/or dataset types become available.

The refinement may also be based on hints associated with that AI model, and/or learned behavior regarding how that AI model is typically used. The obtained results are then refined using the determined refinement. It is then this more relevant refined results that are semantically indexed to generate the semantic index. The semantic index can then be used to provide the suggested queries to the user.

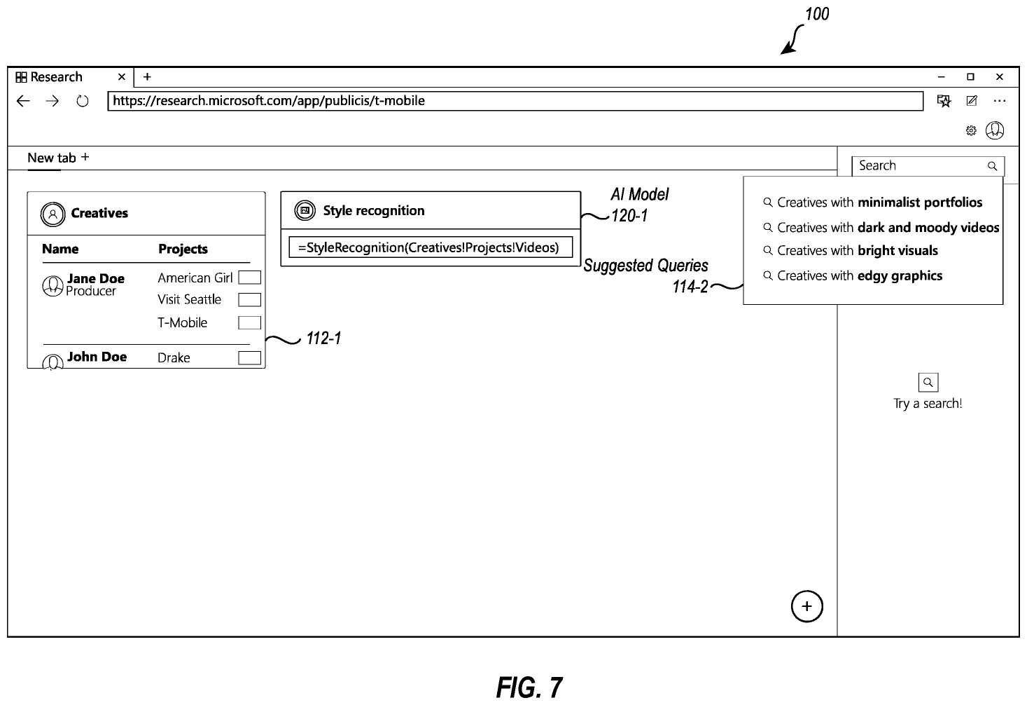

In the example illustrated in FIG. 6, the user selects the style recognition AI model. Thus, as illustrated in FIG. 7 the style recognition AI model 120-1 is added to the AI canvas 100. As noted previously, embodiments may be implemented where the last user action causes a reaction on the AI canvas 100 where the reaction is related to one or more actions the user has previously performed on the AI canvas 100. In particular, as a result of adding the input dataset 112-1, and the AI model 120-1, suggested queries 114-2 are displayed (based on, potentially refined output and/or semantic indexing). In this example, the suggested queries include: ‘creatives with minimalist portfolios’, ‘creatives with dark and moody videos’, ‘creatives with bright visuals’, and ‘creatives with edgy graphics’. These suggested queries 114-2 are based on the fact that the input dataset 112-1 is a dataset with data on ‘creatives’, and that the AI model 120-1 is in AI model configured to identify and recognize styles in multimedia data.

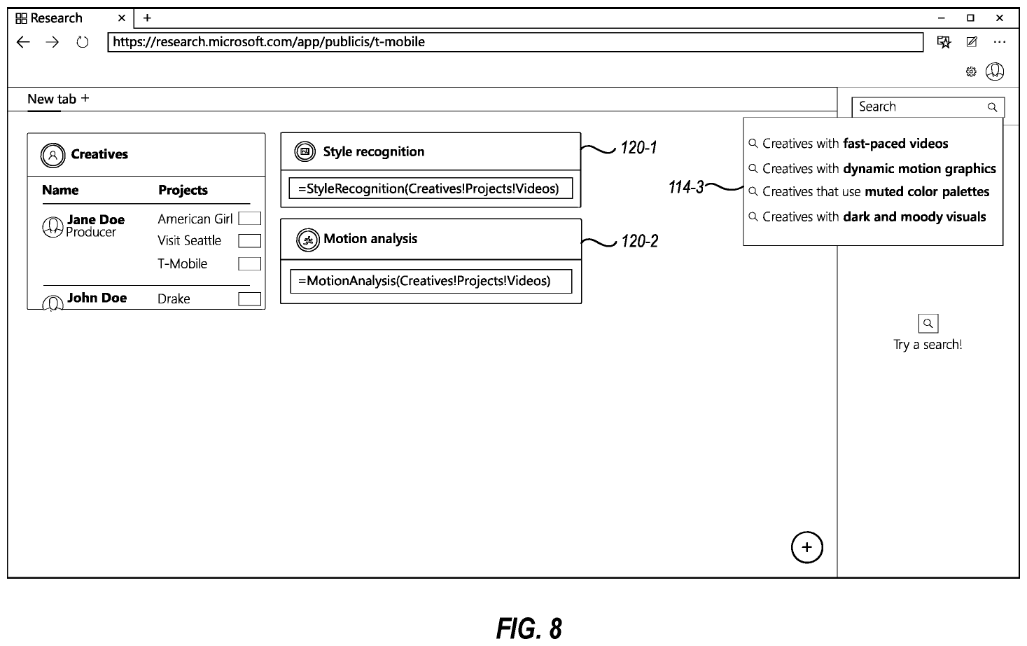

Note that the AI canvas 100 allows a user to add multiple different items from the same class of items. For example, a user can add multiple datasets to the AI canvas 100. Alternatively or additionally, the user can add multiple AI models to the AI canvas 100. For example, FIG. 8 illustrates that the user has added an additional AI model 120-2, where the additional AI model 120-2 is a ‘motion analysis’ AI model. This particular model analyzes multimedia data to identify characteristics related to motion in the multimedia data. As previously noted herein, user interactions will cause read reactions in the AI canvas 100. Those reactions are indicative of historically performed actions on the AI canvas. As noted previously, some of the reactions may be related to only a single recent action, some of the reactions may be related to multiple different previous actions, and/or some reactions may be related to all previous actions performed by the user. Illustratively, the reactions in the illustrated example includes providing suggested queries 114-3. The suggested queries 114-3 includes ‘creatives with fast-paced videos.’ This suggested query is related to the addition of the motion analysis AI model 120-2 but is unrelated to the style recognition AI model 120-1. The suggested queries 114-3 also includes a ‘creatives with dynamic motion graphics’ suggested query. Again, this suggested query is related to the addition of the motion analysis AI model 120-1. The suggested queries 114-3 also includes a ‘creatives that use muted color pallets’ suggested query. This suggested query is related to the addition of the style recognition AI model 120-1. Thus, this is an example of providing a reaction which is not directly related to the most recent action on the AI canvas 100, but is rather related to previous actions while excluding the most recent action. The suggested queries 114-3 also includes a ‘creatives with dark and moody visuals’ suggested query. Again, this is related to the addition of the style recognition AI model 120-1.

FIG. 9 illustrates a user adding a third AI model 120-3. Again, as previously illustrated, this causes various reactions, which in this case, include providing suggested queries 114-4. One of the suggested queries is ‘bright portfolios with upbeat music’. This query provides a suggestion related to both the music analysis AI model 120-3 and the style recognition AI model 120-1. The suggested queries 114-4 also includes a ‘creatives with intense motion graphics’ suggested query. This suggested query relates only to the motion analysis AI model 120-2 and the input dataset 112-1, while not relating to the style recognition AI model 120-1 or the music analysis AI model 120-3. The suggested queries 114-4 further includes a ‘creatives with light and bright videos’. This suggested query relates to the style recognition AI model 120-1, while not being related to the motion analysis AI model 120-2 or the music analysis AI model 120-3. The suggested queries 114-4 further includes a suggested query for ‘creatives with cinematic music’. This particular suggested query relates to the music analysis AI model 120-3, while not being related to the motion analysis AI model 120-2 or the style recognition AI model 120-1.

Note that in some embodiments, the ordering or prominence of display of suggested queries may be based on various factors. For example, the ordering may be based on most recently performed action by a user where suggestions or reactions that are related to the most recent action by the user are displayed more prominently, or in a more prominent position in an ordering, etc.

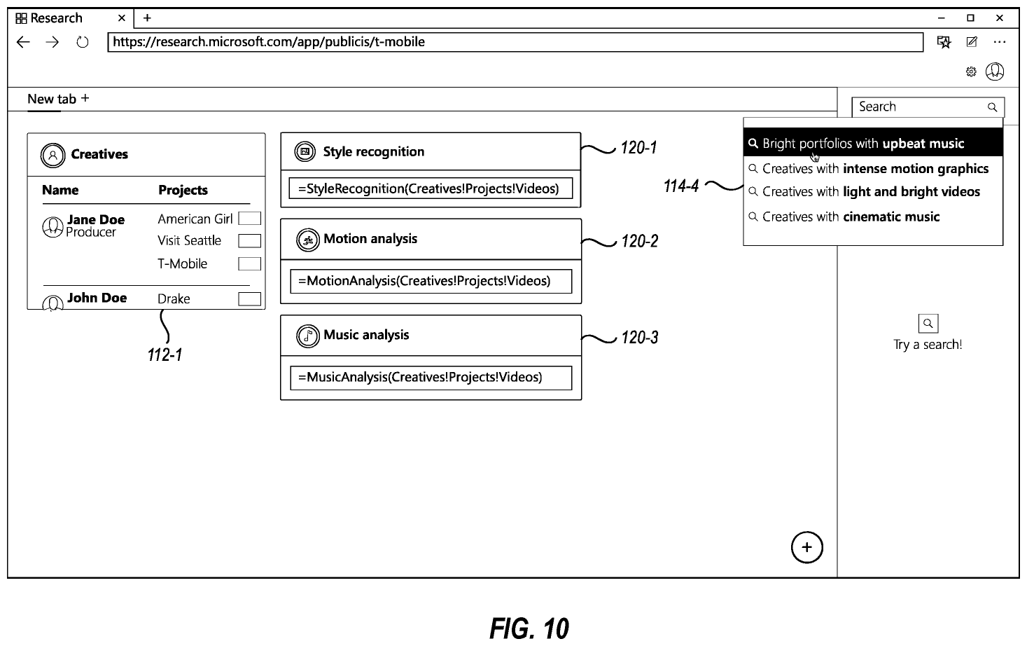

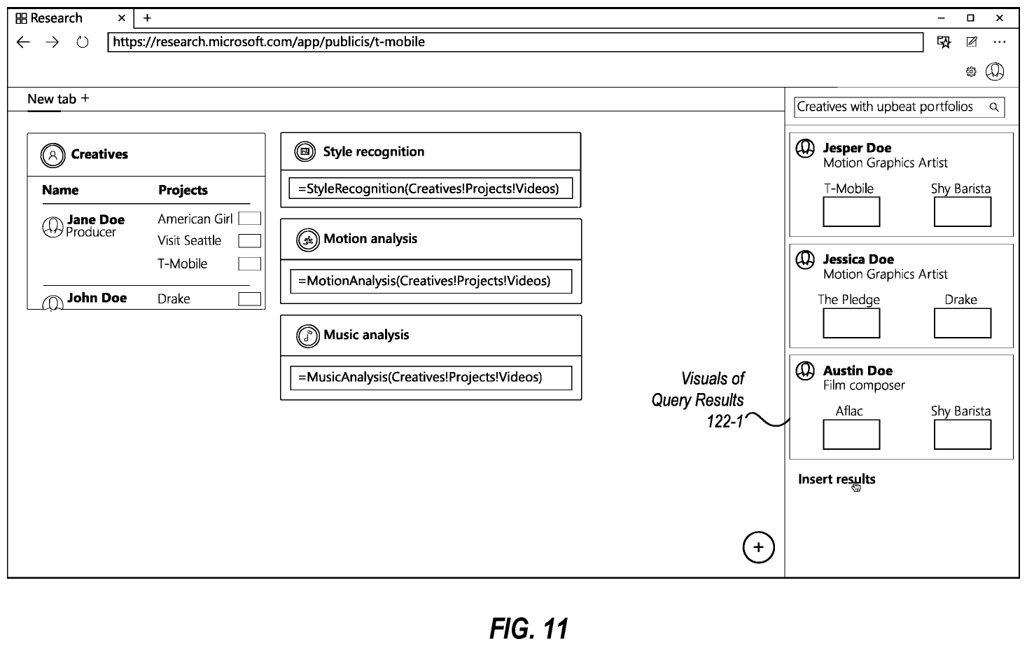

Referring now to FIG. 10, the running example illustrates that a user selects the ‘bright portfolios with upbeat music’ suggested query. This causes the reaction illustrated in FIG. 11. In particular, a visualization of query results 122-1 is shown. In the particular example illustrated, the visualization of query results 122-1 lists the individual creatives' meeting the search criteria grouped together with the multimedia productions produced by those ‘creatives’ that meet the searched criteria. In some embodiments, these search results can be obtained by searching against the semantic index, which can then be used to identify data items from the input dataset. For example, in some embodiments the results of the semantic index search can serve as an entry point into a traditional index which indexes the input dataset. Stated differently, the results of the semantic index search can be used as search terms into a traditional index which indexes the input dataset. Alternatively or additionally, the semantic index may be configured to directly identify data items in the input dataset, which can then be returned and visualized to a user.

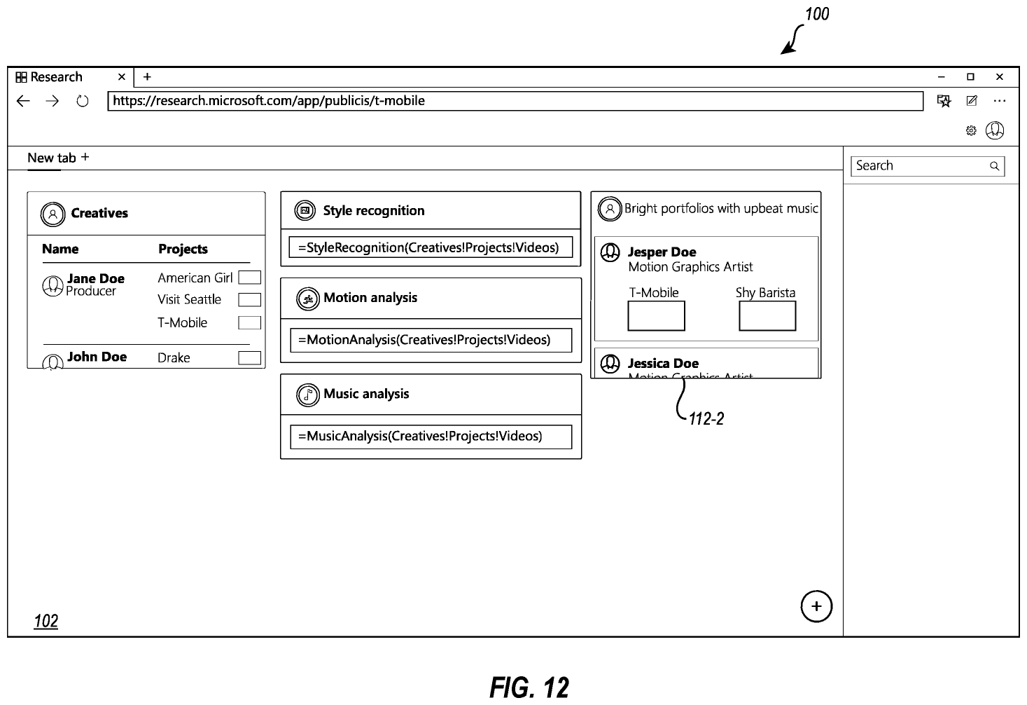

With reference now to FIG. 12, a user may interact on the AI canvas 100 with query results such as the query results shown in the visualization of query results 122-1. In particular, in the example illustrated in FIG. 12, the user can simply drag the query results from the visualization of query results 122-1 on to a working area of the AI canvas 100. This essentially creates a new input dataset 112-2. The working area of the AI canvas is the area where user actions are performed, where the canvas is reactive to user actions in this area.

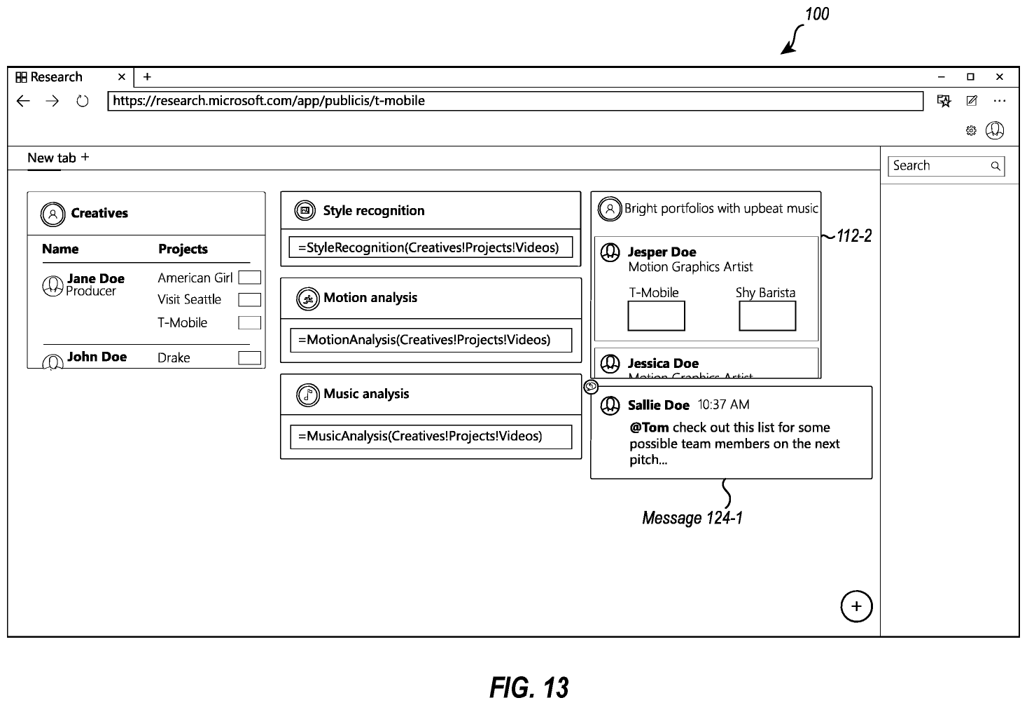

The user can perform a number of different actions on this new input dataset 112-2. For example, as illustrated in FIG. 13, the user could share the input dataset 112-2 with other users. For example, FIG. 13 illustrates an example where a message 124-1 is attached to the input dataset 112-2 and shared with another user along with notes about the results. Note that the user can share various different items with other users. For example, a user may share the entire canvas 100 with other users. Alternatively or additionally, the user may only share the results (i.e., input dataset 112-2) with other users. By sharing the entire AI canvas 100, the user is able to share the decisions being made along with reasons for why the decisions were made such that other users can perform their own analysis and evaluation of the methodology used by the user as well as the conclusions made by the user.

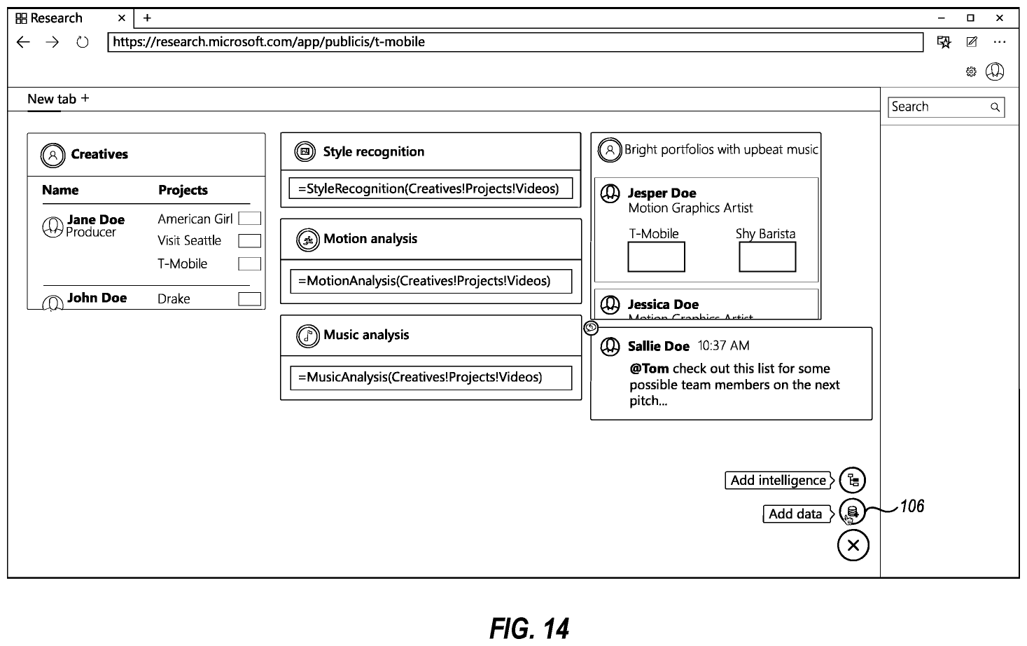

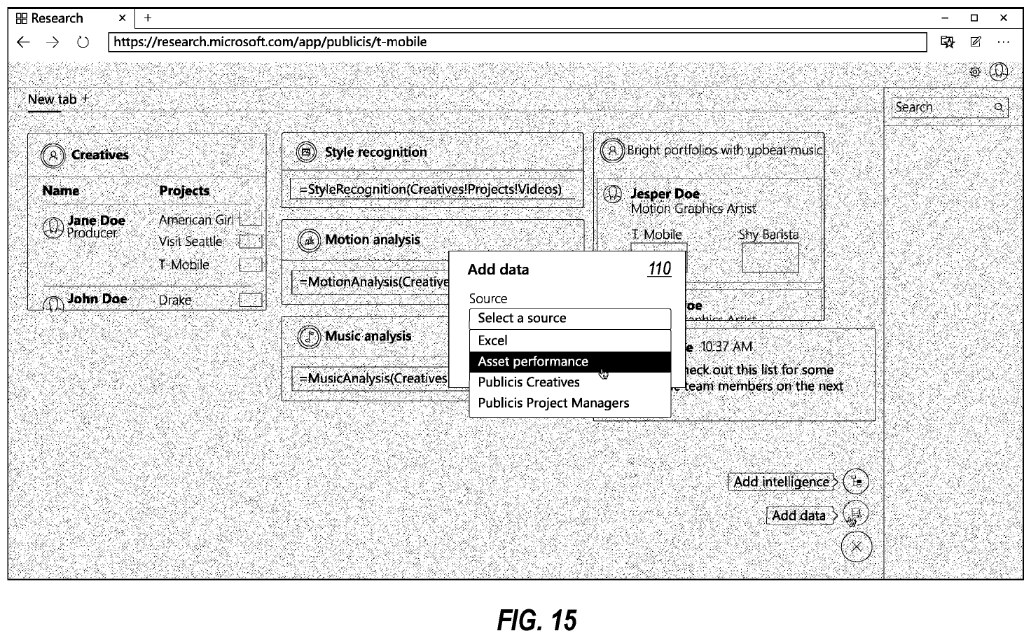

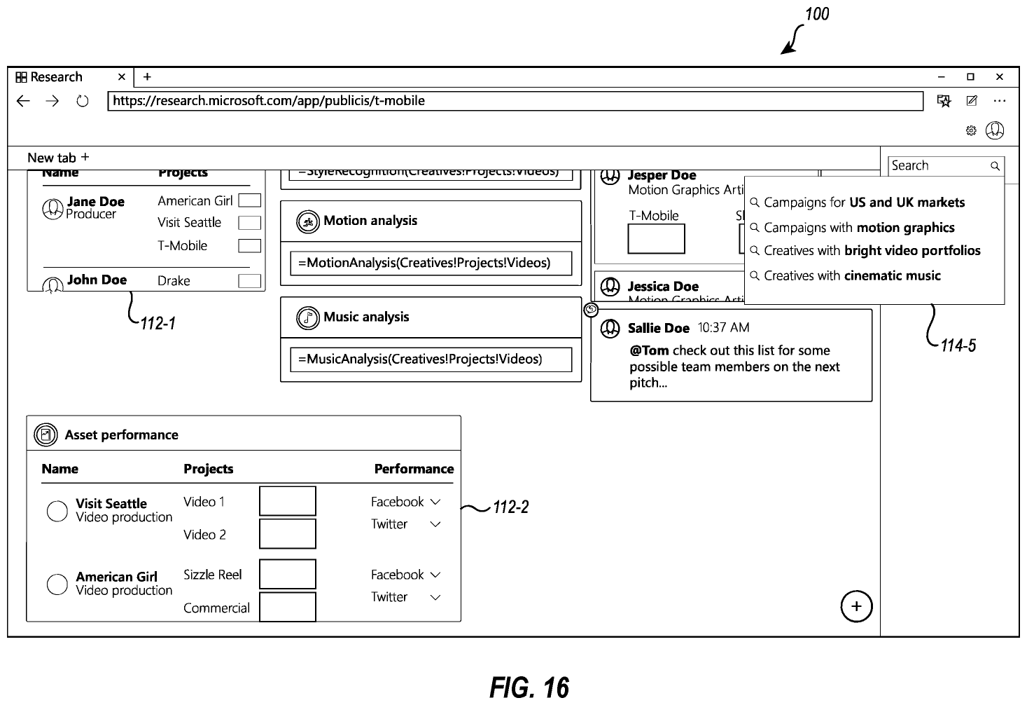

Referring now to FIG. 14, additional details are illustrated where additional input datasets are shown. In particular, FIG. 14 illustrates that a user selects the add data button 106. This causes the add data interface 110 to be displayed. As illustrated in FIG. 15, the user then selects the ‘asset performance’ input dataset. As illustrated in FIG. 16, the asset performance input dataset 112-2 is added to the AI canvas 100. As noted, user interactions cause reactions. In the particular example illustrated, the reactions illustrated in FIG. 16 includes displaying suggested queries 114-5. As illustrated previously, some of these reactions are related to the most recent action performed by a user, while other reactions are related to previous actions by the user without regard to a most recent action. For example, in the illustrated example, the suggested queries 114-5 includes ‘campaigns for US and UK markets’, campaigns with motion graphics’, ‘creatives with bright video portfolios’, and ‘creatives with cinematic music’. Only the first suggested query is related to the addition of the asset performance input dataset 112-2.

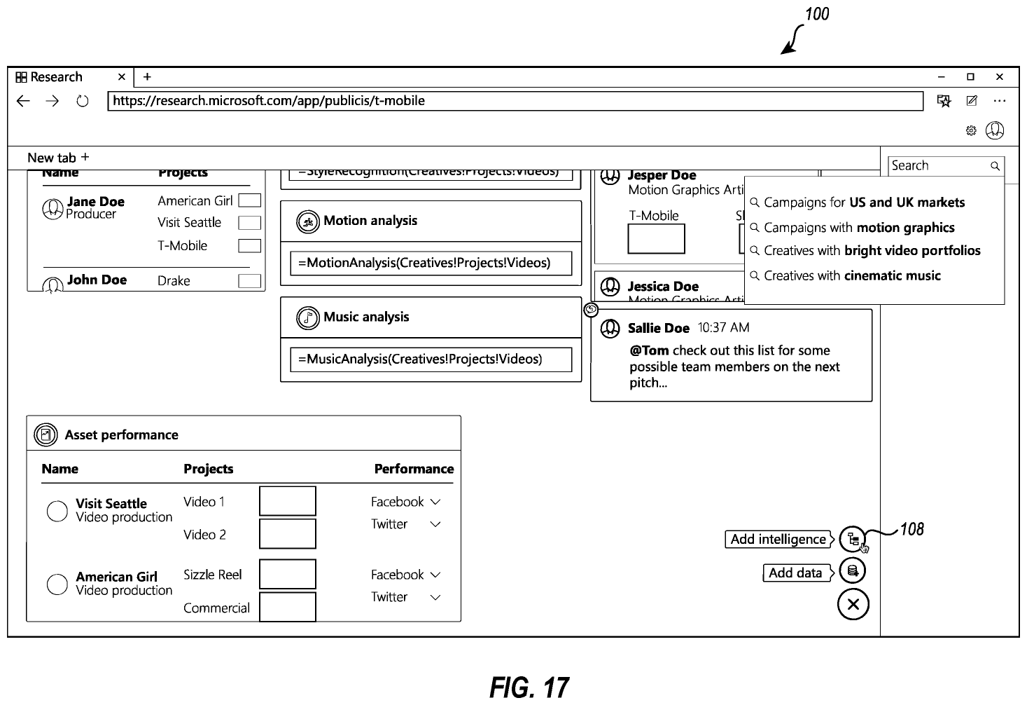

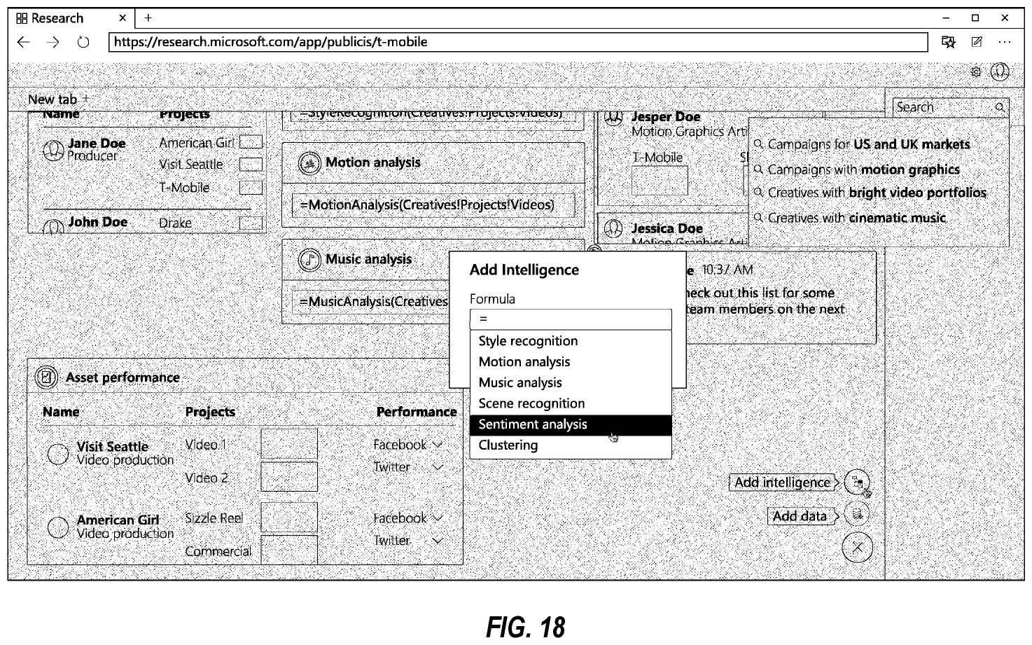

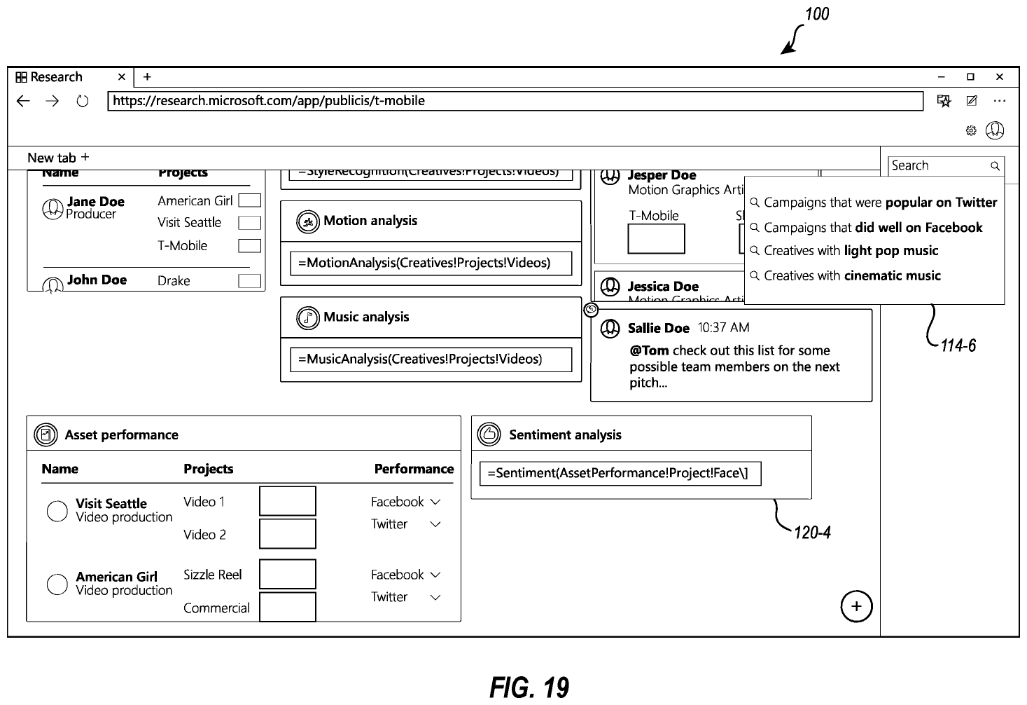

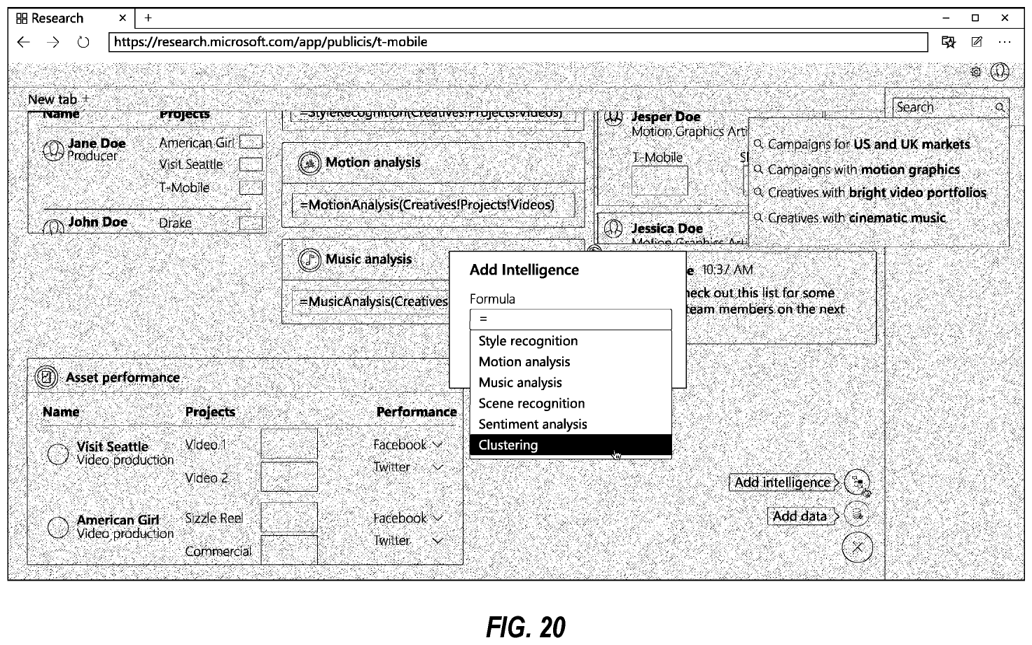

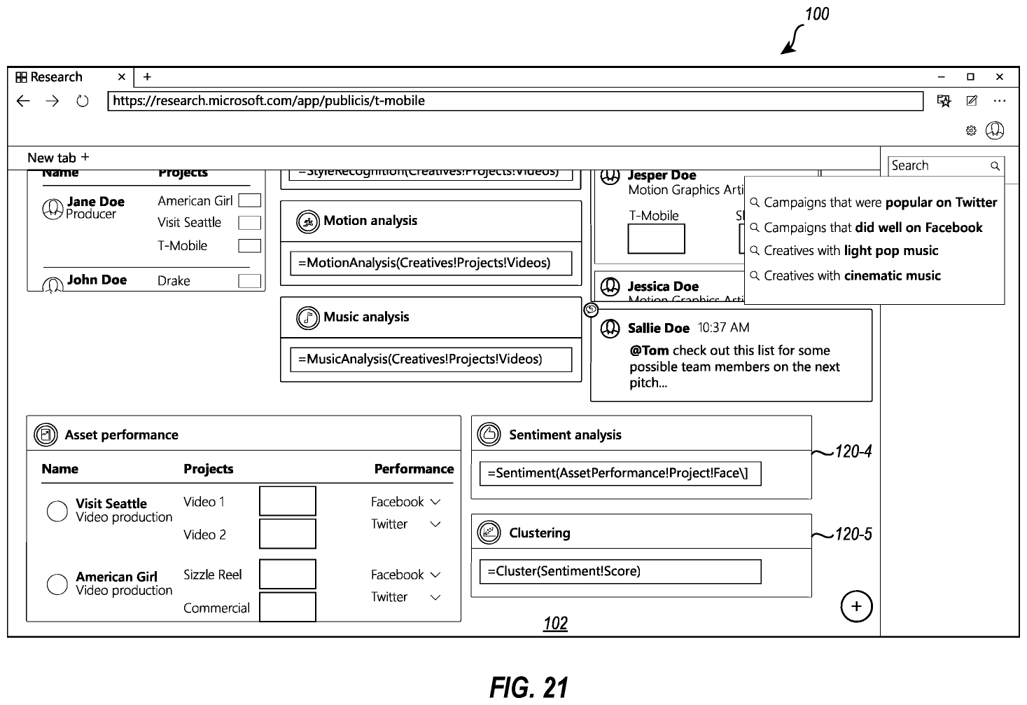

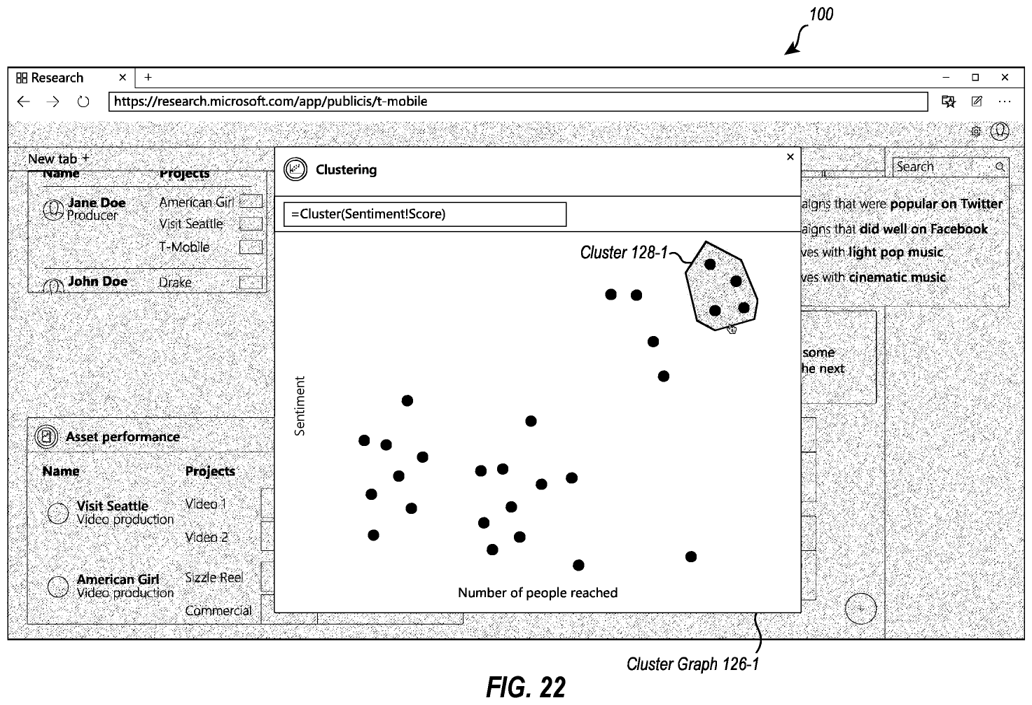

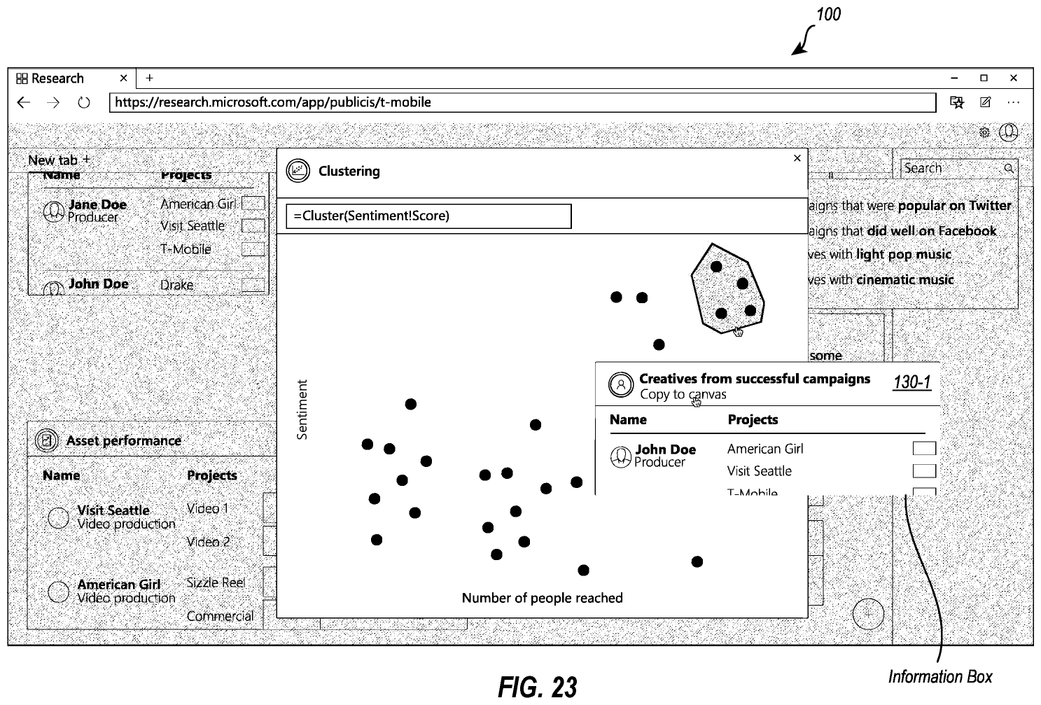

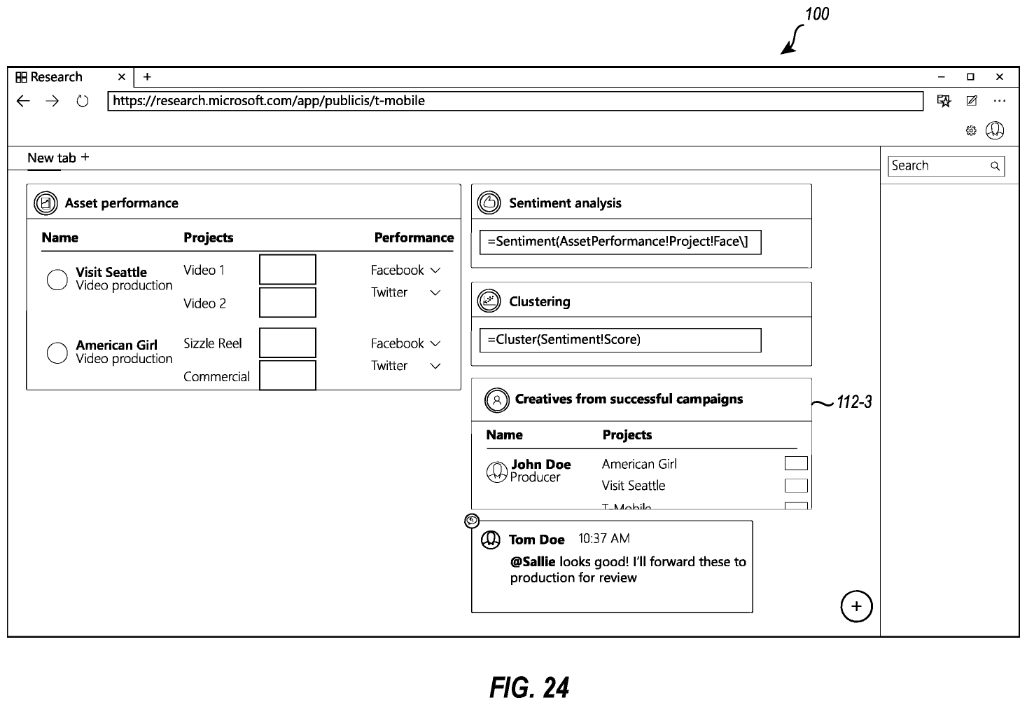

Referring now to FIG. 17, the example illustrates that additional AI models are added to the AI canvas 100. In particular, FIG. 17 illustrates that a user selects the add intelligence button 108. As illustrated in FIG. 18 the user selects the ‘sentiment analysis’ AI model which is then added to the AI canvas 100 and illustrated as AI model 120-4 in FIG. 19. Again, this causes a reaction, which in this case includes providing the suggested queries 114-6. As illustrated in FIG. 20, the user can then add additional AI models. In particular, the user adds a clustering AI model. The results of adding this model are illustrated in FIG. 21 by the addition of the clustering AI model 120-5. Note that this portion of the example illustrates yet additional functionality of the AI canvas 100. In particular, the clustering AI model 120-5 is interactive. In particular, FIG. 21 illustrates that a user can select the clustering AI model 120-5 on the user interface 102. Selecting the clustering AI model 120-5, as illustrated in FIG. 22, results in a cluster graph 126-1 being illustrated in the AI canvas 100. This cluster graph 126-1 shows various campaigns grouped together in clusters according to the results provided by the ‘sentiment analysis’ AI model 120-4. The user can further select given clusters in the cluster graph 126-1. For example, in the example illustrated, the user selects the cluster 128-1 causing the AI canvas 100 to display, as illustrated in FIG. 23, the information box 130-1 showing a visualization of query results that are based on selection of a particular cluster. The user can add the query results from the information box 130-1 to the active area of the AI canvas, as illustrated in FIG. 24 as input dataset 112-3. The active area of the AI canvas is an area that allows a user to specify datasets together with models that should be applied to the datasets. That is, in some embodiments, any AI models added to the active area will be automatically applied to datasets added to the active area. Additionally, FIG. 24 illustrates that all or portions of the AI canvas 100 can be shared with other users along with messages to the other users.

In some embodiments, feedback is provided to the user is based on new semantics added into a semantic space. In particular, the AI canvas 100, which is a computer implemented processor that includes data processors and data analyzers, along with a graphical user interface, is able to identify what words are added to a new or existing semantic space. These may have been added as the result of the user adding new data sources to the AI canvas and/or the result of adding new AI models to the AI canvas 100.

In some embodiments, feedback is provided to the user is based on previous queries that a user has used, which can help to refine what suggested queries are provided in the future. In some such embodiments, suggested queries and/or ranking of queries may be based on last used queries, most frequently used queries, previous queries, collaborative filtering (e.g., what queries do other people use typically), AI machine learning, interaction refinement, etc.

Some embodiments include functionality for undoing previous actions to reset the AI canvas 100 to a previous state. For example, some embodiments may allow user to use the hotkey command ‘control-z’ to undo a previous interaction. In some embodiments this will have the effect of completely removing the interaction as if it had never occurred such that any suggested queries are consistent with the removed reaction having not taken place. However, other embodiments may include functionality for considering all or portions of the actions that were taken when providing suggested queries or other user interface elements. For example, in some embodiments, a determination may be made that the user has certain interests based on elements that were added to the UI canvas even when those elements are removed. Thus, future suggestions and history indications will include elements based on considering the removed interactions. In an alternative or additional example, the system may determine that the user did not like suggested queries or other elements that were provided by the AI canvas such that such suggestions suggested queries or other elements receive a lower weighting and are provided less frequently to the user, and or are actually filtered in total from the user. Indeed, in some embodiments user undoing an action can be considered an action that is used to determine future suggestions or other interactions with the user.

Some embodiments may include functionality for suggesting AI models to a user. For example, embodiments may analyze datasets selected by a user. This may allow the AI canvas to suggest models that are of interest based on the data.

Note that while a specific user interface is illustrated, it should be appreciated that other types of interfaces could be used. For example, in some embodiments, an e-commerce website may be part of the user interface of a AI canvas.

Some embodiments may include a research button. When a user selects the research button, a user interface can identify appropriate UI models and suggest them to a user. For example, based on the data selected by a user, the AI canvas could suggest modes for summarizing data, finding similar sets of data, etc. Alternatively the user could indicate a desire to summarize data, find similar data, etc., exclusive of being presented with a suggested AI models for these actions. The user selecting one of these choices would cause appropriate AI models to be identified and suggested to the user. For example, if the user chose ‘summary’ then additional AI models could be identified, such as clustering models, decision tree models, etc.

Some embodiments may identify and suggest useful AI models, and then identify and suggest additional models based on models applied in a successive manner,

Some embodiments may be useful in e-commerce shopping user interfaces. For example, style models may be suggested to a user. For example, a user could select an item for purchase, and the user could be presented with the ability to select different AI models related to the style of the selected item. When the user selects the particular style, an AI model could be used to find other items that have a similar style. In this way, a user could identify pieces that would coordinate with a selected item. This could allow a user to be their own interior designer. Note, that such models may be based on an art genre, branded models, celebrity endorsed models, etc. The models do not necessarily include objects produced by the branded company, celebrity, etc., but rather would be the types of products that the branded company, designer, celebrity, etc. might endorse or use.

As noted above, embodiments allow a user to share results which allows people with whom the results are shared to see the assumptions and analysis that was performed to come to a conclusion. If the entire AI canvas is shared, then new users can add more models to the working space of the AI canvas. Alternatively, the new users could start a new analysis using the information that was shared. For example, user could do their own analysis and compare their results side-by-side with the shared analysis. The big ability to share the semantics space for the ability of explaining the analysis. Thus, users can either share the whole analysis by sharing the entire canvas or selectively sharing active objects in the canvas.

Some embodiments, as illustrated above include a copy to canvas functionality for copying input data to a canvas. Embodiments can merge outputs to create a larger input dataset. Such embodiments could then include functionality for starting a conversation about the larger dataset. The person who receives the dataset can apply their own analysis. Alternatively, they could be provided with the analysis where they could change certain things about the original analysis. Sharing the canvas allows for sharing explanations and functions.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

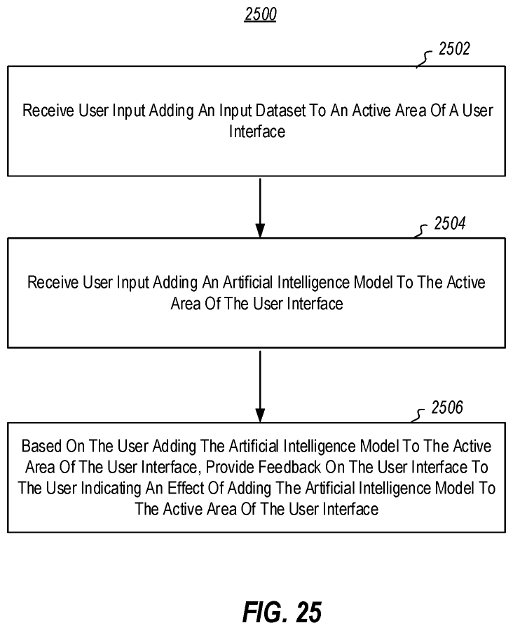

Referring now to FIG. 25, a method 2500 is illustrated. The method 2500 includes acts for providing an improved user interface to a user for facilitating data management produced by artificial intelligence. The method 2500 includes receiving user input adding an input dataset to an active area of a user interface (act 2502). An example of this functionality is illustrated above in the description of FIGS. 1 through 4.

The method 2500 further includes receiving user input adding an artificial intelligence model to the active area of the user interface (act 2504). An example of this functionality is illustrated above in FIGS. 5 through 7.

The method 2500 further includes, based on the user adding the artificial intelligence model to the active area of the user interface, providing feedback on the user interface to the user indicating an effect of adding the artificial intelligence model to the active area of the user interface (act 2506). For example, FIG. 7 illustrates an example where suggested queries 114-2 are provided to a user.

The method 2500 may be practiced where the feedback provides suggests queries to the user that the user could use to search data produced by applying the artificial intelligence model to the dataset. This example is illustrated in the suggested queries 114-2 illustrated in FIG. 7.

The method 2500 may be practiced where the feedback provides suggested additional artificial intelligence models to the user that the user could select to have applied to the dataset.

The method 2500 may further include providing feedback on the user interface to the user indicating the effects of a plurality of user interactions with the user interface.

Thus, for example, suggested queries may be provided to a user where the suggested queries are based on a plurality of different artificial intelligence models added to the user interface.

The method may be practiced where providing feedback on the user interface to the user indicating the effects of a plurality of user interactions with the user interface comprises displaying feedback in a ranked fashion. For example, suggested queries resulting from more recent actions may be placed in a more prominent position in a list of suggested queries. Alternatively or additionally, suggested queries may be highlighted according to a heat map to illustrate ranking. Other ranking illustrations may be used.

In some embodiments, providing feedback on the user interface to the user indicating the effects of a plurality of user interactions with the user interface comprises displaying at least a portion of the feedback based solely on a last model applied to the input dataset. For example, while several artificial intelligence models may be applied to the user interface, in some embodiments, some suggested queries will only be based on the last applied artificial intelligence model rather than two or more models that have been added to the user interface.

The method 2500 may be practiced where the feedback is based on the creation of, or changes to a semantic index caused by applying the artificial intelligence model to the input dataset. In particular, when a semantic index is created, and/or updated, the creation of the semantic index and/or updating the semantic index may be used to provide feedback to the user.

The method 2500 may be practiced where the feedback is further based on previous queries performed by a user. For example, queries selected by a user and/or queries manually input by the user may be used to provide additional suggested queries to a user.

The method 2500 may further include receiving user input to perform a query over data produced by applying the artificial intelligence model to the input dataset. In some such embodiments, and as a result, the embodiments produce a new dataset. Further, such embodiments may add the new dataset to the user interface. Further still, such embodiments may apply artificial intelligence models in the user interface to the new dataset.

The method 2500 may be practiced where the feedback comprises a visualization format that is determined by a type for the artificial intelligence model. For example, FIG. 23 illustrates an example where clusters are provided as visualizations as a result of adding a clustering artificial intelligence model.

The method 2500 may further include receiving user input to perform a query over data produced by applying the artificial intelligence model to the input dataset. In such embodiments, and as a result, embodiments produce a new dataset. Such embodiments may further receive user input to share the new dataset. Such embodiments may further share the new dataset with another user. In particular, embodiments may include functionality for allowing a user to share results of a search or other analysis with other users. In particular, embodiments may allow a user to package the results into a flat file, or other data structure which can then be provided to another user. Alternatively or additionally, embodiments may allow users to share results by sharing access to a data store storing the results and/or an enumeration of datasets and/or artificial intelligence models applied to the datasets. In some embodiments, access to the data store may be provided by providing a location where the data store can be accessed. In some embodiments, this may be accomplished by providing a link to the data in the data store. Alternatively or additionally, the data store location may be published in an accessible location that is accessible to users to whom with which the data should be shared. In some embodiments, users can subscribe to the publisher and thus be automatically notified when new data is available.

In some embodiments, sharing the new dataset comprises sharing all elements added to the user interface by a user such that a new user can evaluate how the new dataset was generated. Alternatively or additionally, some embodiments may simply share results of searches or other analysis.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A ‘network’ is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a ‘NIC’), and then eventually transferred to computer system RANI and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable media having stored thereon instructions that are executable by the one or more processors to configure the computer system to provide an improved user interface to a user for facilitating data management produced by artificial intelligence, including instructions that are executable to configure the computer system to perform at least the following:
receiving user input adding an input dataset to an active area of a user interface;
receiving user input adding an artificial intelligence model to the active area of the user interface; and
based on the user adding the artificial intelligence model to the active area of the user interface, providing feedback on the user interface to the user indicating an effect of adding the artificial intelligence model to the active area of the user interface.

2. The computer system of claim 1, wherein the feedback provides suggested additional artificial intelligence models to the user that the user could select to have applied to the dataset.

3. The computer system of claim 1, wherein the feedback is based on the creation of or changes to a semantic index caused by applying the artificial intelligence model to the input dataset.

4. The computer system of claim 1, further comprising instructions that are executable to configure the computer system to perform at least the following:
receiving user input to perform a query over data produced by applying the artificial intelligence model to the input dataset; and
as a result, producing a new dataset;
adding the new dataset to the user interface; and
applying artificial intelligence models in the user interface to the new dataset.

5. The computer system of claim 1, wherein the feedback comprises a visualization format that is determined by a type for the artificial intelligence model.

6. The computer system of claim 1, further comprising instructions that are executable to configure the computer system to perform at least the following:
receiving user input to perform a query over data produced by applying the artificial intelligence model to the input dataset; and
as a result, producing a new dataset;
receiving user input to share the new dataset; and
sharing the new dataset with another user.

7. The computer system of claim 6, wherein sharing the new dataset comprises sharing all elements added to the user interface by a user such that a new user can evaluate how the new dataset was generated.

8. A method of providing an improved user interface to a user for facilitating data management produced by artificial intelligence, the method comprising:
receiving user input adding an input dataset to an active area of a user interface;
receiving user input adding an artificial intelligence model to the active area of the user interface; and
based on the user adding the artificial intelligence model to the active area of the user interface, providing feedback on the user interface to the user indicating an effect of adding the artificial intelligence model to the active area of the user interface.

9. The method of claim 0, wherein the feedback provides suggests queries to the user that the user could use to search data produced by applying the artificial intelligence model to the dataset.

10. The method of claim 0, wherein the feedback provides suggested additional artificial intelligence models to the user that the user could select to have applied to the dataset.

11. The method of claim 0, further comprising providing feedback on the user interface to the user indicating the effects of a plurality of user interactions with the user interface.

12. The method of claim 11, wherein providing feedback on the user interface to the user indicating the effects of a plurality of user interactions with the user interface comprises displaying feedback in a ranked fashion.

13. The method of claim 11, wherein providing feedback on the user interface to the user indicating the effects of a plurality of user interactions with the user interface comprises displaying at least a portion of the feedback based solely on a last model applied to the input dataset.

14. The method of claim 0, wherein the feedback is based on the creation of or changes to a semantic index caused by applying the artificial intelligence model to the input dataset.

15. The method of claim 0, wherein the feedback is further based on previous queries performed by a user.

16. The method of claim 0, further comprising:
receiving user input to perform a query over data produced by applying the artificial intelligence model to the input dataset; and
as a result, producing a new dataset;
adding the new dataset to the user interface; and
applying artificial intelligence models in the user interface to the new dataset.

17. The method of claim 0, wherein the feedback comprises a visualization format that is determined by a type for the artificial intelligence model.

18. The method of claim 0, further comprising:
receiving user input to perform a query over data produced by applying the artificial intelligence model to the input dataset; and
as a result, producing a new dataset;
receiving user input to share the new dataset; and
sharing the new dataset with another user.

19. The method of claim 18, wherein sharing the new dataset comprises sharing all elements added to the user interface by a user such that a new user can evaluate how the new dataset was generated.

20. A computer system comprising:
one or more processors; and
one or more computer-readable media having stored thereon instructions that are executable by the one or more processors to configure the computer system to implement an improved user interface wherein the user interface comprises:
one or more user interface elements for receiving user input adding an input dataset to an active area of a user interface;
one or more user interface elements for receiving user input adding an artificial intelligence model to the active area of the user interface; and
based on the user adding the artificial intelligence model to the active area of the user interface, one or more user interface elements for providing feedback on the user interface to the user indicating an effect of adding the artificial intelligence model to the active area of the user interface.
